(19) United States
(12) Patent Application Publication
(10) Pub. No.: US 2023/0186035 A1
(43) Pub. Date: Jun. 15, 2023

(54) Textless Speech-to-Speech Translation on Real Data

(71) Applicant: Meta Platforms, Inc., Menlo Park, CA (US)

(72) Inventors: Ann Lee, New York, NY (US); Peng-Jen Chen, New York, NY (US); Holger Schwenk, Palaiseau (FR); Jiatao Gu, Jersey City, NJ (US); Wei-Ning Hsu, Long Island City, CA (US)

(21) Appl. No.: 17/889,116

(22) Filed: Aug. 16, 2022

Related U.S. Application Data
(60) Provisional application No. 63/289,592, filed on Dec. 14, 2021.

(51) Int. Cl. G06F 40/42; G10L 15/06; G10L 21/0208

(52) U.S. Cl. CPC G06F 40/42; G10L 15/063; G10L 21/0208; G10L 2015/0631

(57) ABSTRACT

In one embodiment, a method includes accessing a first utterance of a content by a first speaker, generating first discrete speech units from the first utterance based on a speech-learning model, wherein each of the first discrete speech units is associated with a speech cluster, accessing second utterances of the content by second speakers different from the first speaker, and training a speech normalizer by processing each of the second utterances using the speech normalizer to generate second discrete speech units and updating the speech normalizer by using the first discrete speech units as an optimization target for the second discrete speech units associated with each of the second utterances.

### PRIORITY

This application claims the benefit, under 35 U.S.C. § 119(e), of U.S. Provisional Patent Application No. 63/289,592, filed 14 Dec. 2021, which is incorporated herein by reference.

### TECHNICAL FIELD

This disclosure generally relates to speech processing, and in particular relates to hardware and software for speech processing.

### BACKGROUND

Speech processing is the study of speech signals and the processing methods of signals. The signals are usually processed in a digital representation, so speech processing can be regarded as a special case of digital signal processing, applied to speech signals. Aspects of speech processing includes the acquisition, manipulation, storage, transfer and output of speech signals. The input is called speech recognition and the output is called speech synthesis.

Speech translation is the process by which conversational spoken phrases are instantly translated and spoken aloud in a second language. This differs from phrase translation, which is where the system only translates a fixed and finite set of phrases that have been manually entered into the system. Speech translation technology enables speakers of different languages to communicate. It thus is of tremendous value for humankind in terms of science, cross-cultural exchange and global business.

### SUMMARY OF PARTICULAR EMBODIMENTS

In particular embodiments, a normalizer may be used for normalizing real-world speech data to train a textless speech-to-speech translation model. The speech-to-speech translation model may translate speech in one language to another language without the intermediate step of generating text transcriptions. Previous work has used synthetic speech data (e.g., using text-to-speech technology to generate training speech data) to train textless speech-to-speech translation models. However, the synthetic speech data may be clean by nature, which may not reflect the real-world scenarios (e.g., background noise, poor data collection condition, etc.). To use real-world speech data to train the textless speech-to-speech translation model, one challenge may be that the utterances of the same content by different people could sound different (e.g., their sound wave may look different due to accent). To address this issue, a normalizer may be trained and then used as a pre-processing step to clean the training speech data so that the speech signals would look roughly the same when different people utter the same content. The normalizer may use self-supervised discrete representations from a reference speaker's speech and finetune a pre-trained speech encoder with paired audio from multiple speakers and the reference speaker to remove the variations, while maintaining the content. Although this disclosure describes a particular normalizer in a particular manner, this disclosure contemplates any suitable normalizer in any suitable manner.

In particular embodiments, a computing system may access a first utterance of a content by a first speaker. The computing system may then generate, based on a speech-learning model, a plurality of first discrete speech units from the first utterance. In particular embodiments, each of the plurality of first discrete speech units may be associated with a speech cluster. The computing system may then access one or more second utterances of the content by one or more second speakers different from the first speaker. The computing system may further train a speech normalizer by processing each of the one or more second utterances using the speech normalizer to generate a plurality of second discrete speech units and updating the speech normalizer by using the plurality of first discrete speech units as an optimization target for the plurality of second discrete speech units associated with each of the one or more second utterances.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates example audio samples.

FIG. 2 illustrates an example self-supervised unit-based speech normalization process.

FIG. 3 illustrates an example textless speech-to-speech translation (S2ST) model.

FIG. 4 illustrates example BLEU scores on Europarl-ST Es-En test set from S2UT systems trained with 1-hr norm-unit.

FIG. 5 illustrates an example method for training a speech normalizer.

FIG. 6 illustrates an example computer system.

### DESCRIPTION OF EXAMPLE EMBODIMENTS

In particular embodiments, a normalizer may be used for normalizing real-world speech data to train a textless speech-to-speech translation model. The speech-to-speech translation model may translate speech in one language to another language without the intermediate step of generating text transcriptions. Previous work has used synthetic speech data (e.g., using text-to-speech technology to generate training speech data) to train textless speech-to-speech translation models. However, the synthetic speech data may be clean by nature, which may not reflect the real-world scenarios (e.g., background noise, poor data collection condition, etc.). To use real-world speech data to train the textless speech-to-speech translation model, one challenge may be that the utterances of the same content by different people could sound different (e.g., their sound wave may look different due to accent). To address this issue, a normalizer may be trained and then used as a pre-processing step to clean the training speech data so that the speech signals would look roughly the same when different people utter the same content. The normalizer may use self-supervised discrete representations from a reference speaker's speech and finetune a pre-trained speech encoder with paired audio from multiple speakers and the reference speaker to remove the variations, while maintaining the content. Although this disclosure describes a particular normalizer in a particular manner, this disclosure contemplates any suitable normalizer in any suitable manner.

In particular embodiments, a computing system may access a first utterance of a content by a first speaker. The computing system may then generate, based on a speech-learning model, a plurality of first discrete speech units from the first utterance. In particular embodiments, each of the plurality of first discrete speech units may be associated with a speech cluster. The computing system may then access one or more second utterances of the content by one or more second speakers different from the first speaker. The computing system may further train a speech normalizer by processing each of the one or more second utterances using the speech normalizer to generate a plurality of second discrete speech units and updating the speech normalizer by using the plurality of first discrete speech units as an optimization target for the plurality of second discrete speech units associated with each of the one or more second utterances. Although this disclosure describes accessing a single utterance, this disclosure contemplates accessing any suitable number of utterances, e.g., a batch of utterances, in any suitable manner.

The embodiments disclosed herein present a textless speech-to-speech translation (S2ST) system that may translate speech from one language into another language and may be built without the need of any text data. Different from existing work in the literature, the embodiments disclosed herein tackle the challenge in modeling multi-speaker target speech and train the systems with real-world speech-to-speech translation (S2ST) data. The key to our approach may comprise a self-supervised unit-based speech normalization technique, which may finetune a pre-trained speech encoder with paired audios from multiple speakers and a single reference speaker to reduce the variations due to accents, while pre-serving the lexical content. With only 10 minutes of paired data for speech normalization, we obtain on average 3.2 BLEU gain when training the S2ST model on a first experimental multilingual S2ST dataset, compared to a baseline trained on un-normalized speech target. The embodiments disclosed herein also incorporate automatically mined speech-to-speech translation (S2ST) data and show an additional 2.0 BLEU gain. To our knowledge, the embodiments disclosed herein may be the first to establish a textless speech-to-speech translation (S2ST) technique that may be trained with real-world data and may work for multiple language pairs.

Speech-to-speech translation (S2ST) technology may help bridge the communication gap between people speaking different languages. Conventional speech-to-speech translation (S2ST) systems usually rely on a cascaded approach by first translating speech into text in the target language, either with automatic speech recognition (ASR) followed by machine translation (MT), or an end-to-end speech-to-text translation (S2T) model, and then applying text-to-speech (TTS) synthesis to generate speech output.

On the other hand, researchers have started exploring direct speech-to-speech translation (S2ST), which aims at translating speech in the source language to speech in the target language without the need of text generation as an intermediate step. However, text transcriptions or phoneme annotations of the speech data may be still needed during model training for multitask learning or for learning a decoder that generates intermediate representations to facilitate the generation of speech output.

More than 40% of the languages in the world may be without text writing systems, while limited work may exist to tackle the challenge of training direct speech-to-speech translation (S2ST) systems without the use of any text data. Moreover, due to the lack of speech-to-speech translation (S2ST) training data, previous work on direct S2ST may rely on TTS to generate synthetic target speech for model training. The recent release of the large-scale S2ST data from the first experimental multilingual S2ST dataset may have opened up the possibility of conducting speech-to-speech translation (S2ST) on real data. In addition, prior work has demonstrated the first proof of concept of direct S2S mining without using ASR or machine-translation (MT) systems. The approach may potentially mitigate the data scarcity issue, but there was no evaluation of the usefulness of such data for speech-to-speech translation (S2ST) frameworks.

Most recently, a prior work has proposed to take advantage of self-supervised discrete representations, or discrete units, learned from unlabeled speech data as the target for building a direct speech-to-speech translation (S2ST) model. Experiments conducted with synthetic target speech data have shown significant improvement for translation between unwritten languages. The embodiments disclosed herein extend the textless speech-to-speech translation (S2ST) setup by training a speech-to-speech translation (S2ST) system without the use of any text or phoneme data, and conduct experiments on real speech-to-speech translation (S2ST) datasets, including the first experimental multilingual S2ST dataset and automatically mined speech-to-speech translation (S2ST) data. To tackle the challenge of modeling real target speech where there are multiple speakers with various accents, speaking styles and recording conditions, etc., the embodiments disclosed herein propose a speech normalization technique that finetunes a self-supervised pre-trained model for speech with a limited amount of parallel multiple-to-single speaker speech. Experiments on four language pairs show that when trained with the normalized target speech obtained from a speech normalizer trained with 10-min parallel data, the performance of a textless S2ST model can be improved by 3.2 BLEU points on average compared with a baseline with un-normalized target speech.

The main contributions of the embodiments disclosed herein may be as follows. The embodiments disclosed herein propose a speech normalization technique based on self-supervised discrete units that may remove the variations in speech from multiple speakers without changing the lexical content. The embodiments disclosed herein apply the technique on the target speech of real speech-to-speech translation (S2ST) data and verify its effectiveness in the context of textless speech-to-speech translation (S2ST). The embodiments disclosed herein empirically demonstrate that with the speech normalization technique. We may further improve the performance of a textless speech-to-speech translation (S2ST) system by augmenting supervised speech-to-speech translation (S2ST) data with directly mined S2ST data, demonstrating the usefulness of the latter. To the best of our knowledge, the embodiments disclosed herein may be the first to establish a textless speech-to-speech translation (S2ST) technique that may be trained with real-world data, and the technique may work for multiple language pairs.

In particular embodiments, the speech-to-speech translation (S2ST) system may use HuBERT to discretize target speech and build a sequence-to-sequence speech-to-unit translation (S2UT) model. We describe the proposed speech normalization method and the S2UT system below.

In particular embodiments, generating the plurality of first discrete speech units may comprise generating a plurality of intermediate representations by processing the first utterance with the speech-learning model and applying one or more clustering algorithms to the plurality of intermediate representations. Hidden-unit BERT (HuBERT) may take an iterative process for self-supervised learning for speech. In each iteration, K-means clustering may be applied on the model's intermediate representations (or the Mel-frequency cepstral coefficient features for the first iteration) to generate discrete labels for computing a BERT-like loss. After the last iteration, K-means clustering may be performed again on the training data, and the learned K cluster centroids may be used to transform audio into a sequence of cluster indices as [z₁, z₂, . . . , z_{T}], zᵢ ∈{0, . . . , K−1}, ∀1≤i≤T where T is the number of frames. We refer to these units as orig-unit.

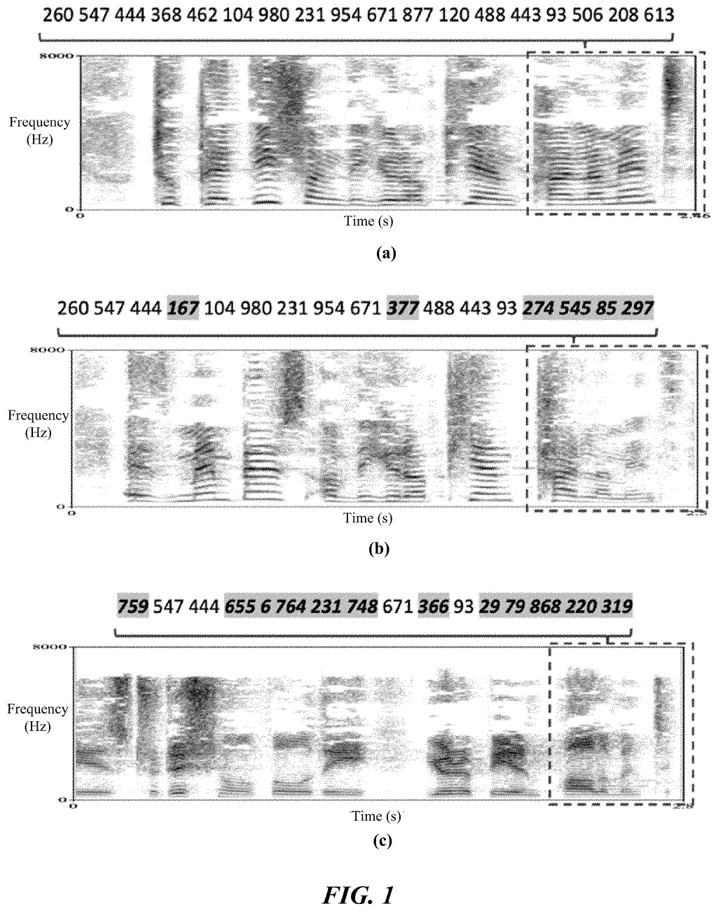

FIG. 1 illustrates example audio samples. The samples are from one female ((a) and (b)) and one male speaker ((c)) from the experimental multilingual S2ST dataset for the word “parliament”. FIG. 1 also illustrates the reduced units (consecutive duplicate units removed) encoded by the HuBERT model, which will be described later in the embodiments disclosed herein. Differences in the units with respect to (a) are marked, e.g., units 105-135. We may observe that orig-unit from audios of different speakers speaking the same content may be quite different due to accent and other residual variations such as silence and recording conditions, while there may be less variation in orig-unit from speech from the same speaker from FIG. 1. Following the success of self-supervised pre-training and Connectionist Temporal Classification (CTC) finetuning for ASR, we propose to build a speech normalizer by performing CTC finetuning with a pre-trained speech encoder using multi-speaker speech as input and discrete units from a reference speaker as target.

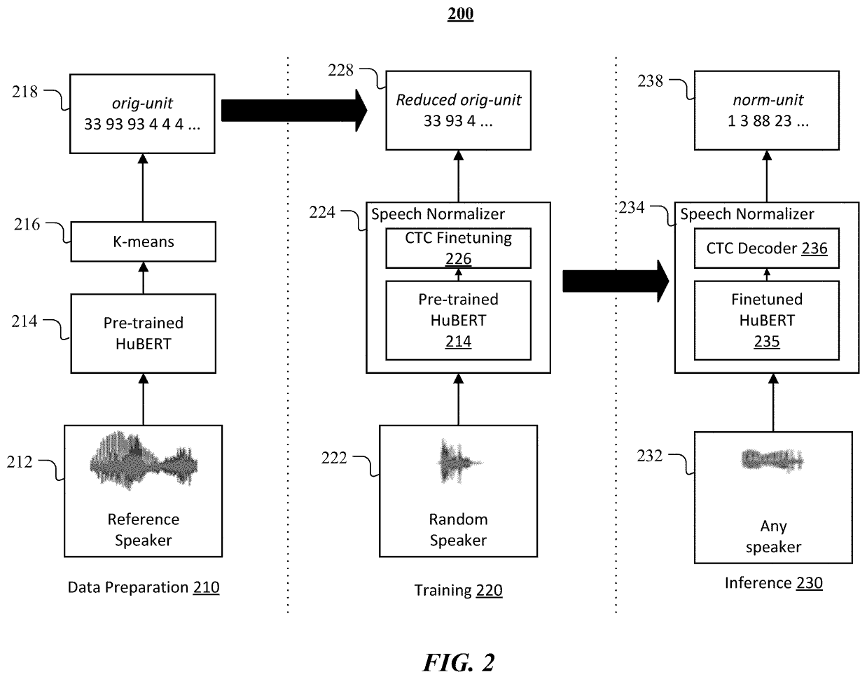

FIG. 2 illustrates an example self-supervised unit-based speech normalization process 200. To begin with, a pair of audios from a random speaker and a reference speaker speaking the same content may be required. During data preparation 210, orig-unit sequences may be extracted for audios 212 from the reference speaker. Then, we may convert the reference speaker speech 212 into orig-unit 218 with the pre-trained HuBERT model 214 followed by K-means clustering 216. In particular embodiments, the computing system may reduce one or more repeating first content units from the plurality of first content units. We may further reduce the full orig-unit sequence 218 by removing repeating units. The resulting reduced orig-unit 228 may serve as the target in the CTC finetuning stage with the speech from the random speaker as the input. During training 220, we may input audio 222 from different speakers speaking the same content to a speech normalizer 224 comprising the pre-trained HuBERT model 214 and CTC finetuning 226. We may apply CTC finetuning 226 with reduced orig-unit 228 from the reference speaker as the target. In particular embodiments, the trained speech normalizer may comprise one or more of a finetuned speech-learning model or a decoder. During inference 230, we may apply the finetuned speech normalizer 234 comprising a finetuned HuBERT model 235 and a CTC decoder 236 to the audio 232 from any speaker. We may then obtain norm-unit 238 from CTC decoding. In particular embodiments, the computing system may access a third utterance by a third speaker and process the third utterance using the trained speech normalizer to generate a plurality of normalized speech units. The process may be viewed as training an ASR model with the “pseudo text”, i.e., units from speech from a single reference speaker. The resulting speech normalizer 234 may be a discrete unit extractor that converts the input speech to units with CTC decoding. We refer to these units as norm-unit 238.

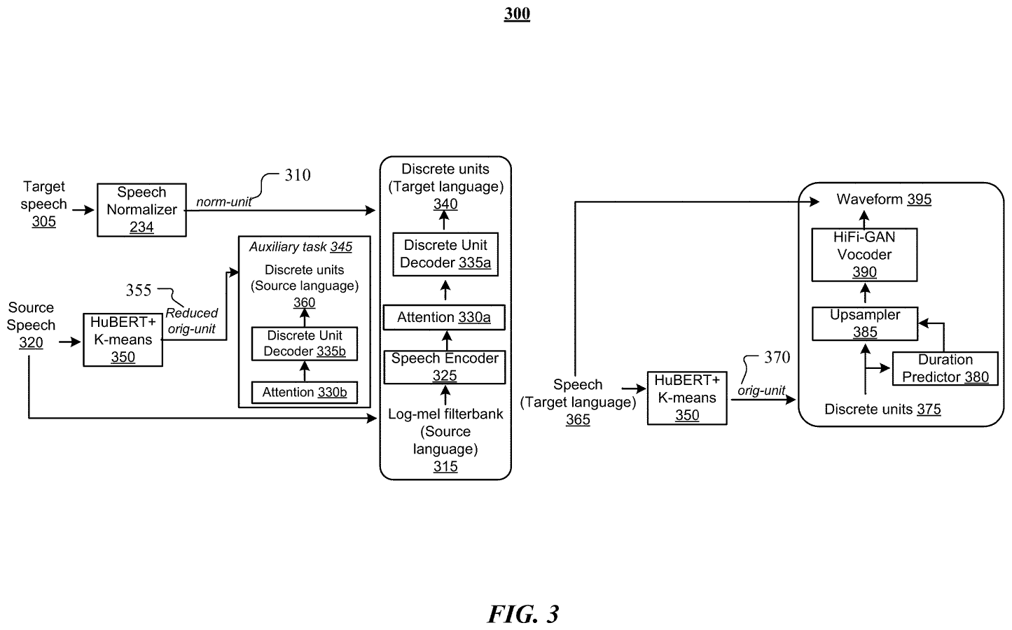

FIG. 3 illustrates an example textless speech-to-speech translation (S2ST) model 300. In particular embodiments, the computing system may process a plurality of first training data associated with a target language by the trained speech normalizer to generate a plurality of normalized target speech units. The computing system may then train a textless speech-to-speech translation (S2ST) model 300 based on the plurality of normalized target speech units and a plurality of second training data associated with a source language. In particular embodiments, the textless speech-to-speech translation (S2ST) model 300 may comprise a speech-to-unit translation (S2UT) model with an auxiliary task and a unit-based HiFi-GAN vocoder for unit-to-speech conversion.

As illustrated in FIG. 3, the computing system may apply the speech normalizer 234 to target speech 305 to generate norm-unit 310 as the target for training the S2UT model. In particular embodiments, the logmel filterbank (source language) 315 generated from the source speech 320 may be input to a speech encoder 325. The speech encoder 325 may be built by pre-pending a speech downsampling module to a stack of transformer blocks. The downsampling module may comprise two one-dimensional (1D) convolutional layers, each with stride 2 and followed by a gated linear unit activation function, resulting in a downsampling factor of 4 for the logmel filterbank 315 input. The output from the speech encoder 325 may be provided to an attention module 330a. The output from the attention module 330a may be provided to a discrete unit decoder 335a, which may output discrete units (target language) 340. In particular embodiments, the discrete unit decoder 335a may comprise a stack of transformer blocks as in machine translation and may be trained with cross-entropy loss with label smoothing. The setup may be viewed as a “reduced” strategy, as the speech normalizer may be trained on reduced orig-unit sequences.

In particular embodiments, the S2UT model may be associated with an auxiliary task 345. An auto-encoding style auxiliary task 345 may be incorporated to help the model converge during training. We may add a cross-attention module and a transformer decoder to an intermediate layer of the speech encoder and use reduced orig-unit of the source speech as the target. As illustrated in FIG. 3, the source speech 320 may be processed based on HuBERT and K-means 350, which may generate the reduced orig-unit 355. For the auxiliary task 345, the reduced original-unit 355 may be provided to another attention module 330b. The output from the attention module 330b may be provided to another discrete unit decoder 335b, which may output discrete units (source language) 360.

In particular embodiments, the unit-to-speech conversion may be done with the discrete unit-based HiFi-GAN vocoder 390, enhanced with a duration predictor 380. The vocoder 390 may be trained separately from the S2UT model with the combination of the generator-discriminator loss from HiFi-GAN and the mean square error (MSE) of the predicted duration of each unit in logarithmic domain. As illustrated in FIG. 3, the speech in target language 365 may be processed based on HuBERT and K-means 350, which may generate the orig-unit 370. The discrete units 375 may be input to an upsampler 385 and the duration predictor 380. The output from the duration predictor 380 may be also input to the upsampler 385. The output of the upsampler 385 may be provided to the HiFi-GAN vocoder 390, which may output the waveform 395 as the translated speech.

Besides for training a textless speech-to-speech translation (S2ST) model 300, the trained speech normalizer may be used for other applications. In one application, the trained speech normalizer may be used to filter out the speech characteristics of a speaker to anonymize the speaker. In particular embodiments, the computing system may anonymize the third speaker based on removing one or more normalized speech units associated with speech characteristics specific to the third speaker from the plurality of normalized speech units. In another application, the trained speech normalizer may be used to remove the background noise, abnormally long silence, etc. In particular embodiments, the computing system may denoise the third utterance based on removing one or more normalized speech units corresponding to background noises from the plurality of normalized speech units. In particular embodiments, the computing system may remove one or more normalized speech units corresponding to silence longer than a threshold time from the plurality of normalized speech units.

TABLE 1
Number of samples of the data used in training speech normalizers.

| | | | |
|---|---|---|---|
| duration | English | Spanish | French |

| | | | | | |
|---|---|---|---|---|---|
| train | 10 | mins | 89 | 97 | 86 |
| | 1 | hr | 522 | 612 | 510 |
| | | | | (61% CV) | |
| | 10 | hrs | 5.1k | 6.7k | 5.9k |
| | | | | (96% CV) | (56% CV) |

| | | | |
|---|---|---|---|
| dev | 1.2k | 1.5k | 1.5k |

We examine four language pairs: Spanish-English (Es-En), French-English (Fr-En), English-Spanish (En-Es), and English-French (En-Fr). All experiments are conducted using fairseq, a sequence-to-sequence learning toolkit.

As we focus on modeling target speech in En, Es or Fr, we train a single multilingual HuBERT (mHuBERT) model by combining data from three languages. We use the 100k subset of the unlabeled speech of the first experimental multilingual S2ST dataset, which contains 4.5k hours of data for En, Es and Fr, respectively, totaling 13.5k hours.

We use multi-speaker speech from the first experimental multilingual S2ST ASR dataset and convert text transcriptions to reference units for training the speech normalizer. The text-to-unit (T2U) conversion may be done with a transformer machine-translation (MT) model trained on single-speaker TTS data with characters as input and reduced orig-unit as target.

We build training sets of three different sizes (10-min, 1-hr, 10-hr) for each language (Table 1). For Spanish and French, as there is not enough data from the first experimental multilingual S2ST ASR dataset after filtering out the overlap with the S2ST data, we include random samples from an experimental voice audio dataset (denoted as CV). We remove the audios that exist in the first experimental multilingual S2ST dataset and randomly sample from the experimental voice audio ASR dataset if there is not enough data. We also randomly sample 1000 audios from the experimental voice audio dev sets and combine with the filtered first experimental multilingual S2ST ASR dev sets for model development. Though the reference target is created synthetically, we believe that collecting a maximum of 10-hr speech from a single speaker may be reasonable as in TTS data collection.

We use the first experimental multilingual S2ST dataset as the supervised S2ST data for model training. Take Es-En for example. We combine data from English source speech to English interpretation with Spanish interpretation to English source speech for training. We evaluate on the dev set and test set from an experimental European multilingual dataset, as it provides text translation for BLEU score computation and is of the same domain as the first experimental multilingual S2ST dataset. In addition, we investigate incorporating speech-to-speech translation (S2ST) data automatically mined from an experimental read audiobooks dataset. Table 2 summarizes the statistics of the data for each language pair. We train the models on a second experimental multilingual dataset (VP) and mined S2ST data and evaluate on the experimental European multilingual dataset (EP). The source speech from plenary sessions before 2013 are removed from VP to avoid overlap with EP, resulting in different amounts of data between X-Y and Y-X language pairs. (*: speech is created with TTS for tracking dev loss during training.)

TABLE 2
Statistics of the data used in S2UT model training.

| | Es-En | | | | Fr-En | | | | En-Es | | | | En-Fr | | | |
|---|---|---|---|---|---|---|---|---|---|---|---|---|---|---|---|---|
| | | | EP | | | | EP | | | | EP | | | | EP | |
| | VP | mined | dev | test | VP | mined | dev | test | VP | mined | dev | test | VP | mined | dev | test |
| # | 159k | 314k | 1.9k | 1.8k | 156k | 338k | 1.5k | 1.8k | 126k | 314k | 1.3k | 1.3k | 138k | 338k | 1.3k | 1.2k |
| samples | | | | | | | | | | | | | | | | |
| source | 532.1 | 441.7 | 5.4 | 5.1 | 522.9 | 447.1 | 3.7 | 4.7 | 414.7 | 424.7 | 3.0 | 2.9 | 450.6 | 469.5 | 3.0 | 2.8 |
| (hrs) | | | | | | | | | | | | | | | | |
| target | 513.1 | 424.7 | 5.6* | — | 507.3 | 469.5 | 3.9* | — | 424.1 | 441.7 | 3.0* | — | 456.0 | 447.1 | 3.0* | — |
| (hrs) | | | | | | | | | | | | | | | | |

TABLE 3
Duration of the TTS datasets after VAD.

duration (hrs)

| | dataset | train | dev |
|---|---|---|---|
| English | Short-audio speech dataset | 22.3 | 0.7 |
| Spanish | 10-language speech dataset | 20.8 | 0.2 |
| French | 10-language speech dataset | 17.7 | 0.2 |

We train the unit-based HiFi-GAN vocoder using TTS data, pre-processed with VAD to remove silence at both ends of the audio. No text data may be required during vocoder training. In addition, we use the same TTS dataset to train the T2U model for generating reference target units in speech normalizer training and to build the cascaded baselines.

We build a single mHuBERT model for all three languages using the combination of 13.5k-hr data without applying any language-dependent weights or sampling, since the amount of data is similar between all three languages. A single codebook may be used for all three languages, and no language information may be required during pre-training. The mHuBERT model may be pre-trained for three iterations. In each iteration, model weights may be randomly initialized and optimized for 400k steps. We find that K=1000 with features from the 11-th layer of the third iteration mHuBERT model work the best for our experiments.

The baselines may comprise S2UT with reduced orig-unit and S2T+TTS. First, we consider a basic setup by training the S2UT system using reduced orig-unit extracted from the target multi-speaker speech with mHuBERT. For the second baseline, we concatenate a d-vector speaker embedding to each frame of the speech encoder output to incorporate target speaker information. A linear layer is applied to map the concatenated feature vectors to the same dimension as the original encoder output. The 256-dimensional speaker embedding, which remains fixed during the S2UT model training, is extracted from a speaker verification model pre-trained on an experimental celebrity speech dataset. During inference, we use the speaker embedding averaged from all audios from the TTS dataset of the target language.

In addition, we transcribe all the S2ST data with open-sourced ASR models and train a S2T+TTS system for each language pair. We build 2000 unigram subword units from the ASR decoded text as the target. For TTS, we explore two approaches including transformer TTS and text-to-unit (T2U). The transformer TTS model may have a text encoder, a spectrogram decoder and a HiFi-GAN vocoder. The T2U model may be the same model used in preparing reference units for speech normalizer training, and we may apply the same unit-based vocoder for the S2UT model for unit-to-speech conversion. Both transformer TTS and T2U are trained with characters as input.

To evaluate translation quality, we first use open-sourced ASR models to decode speech output from all systems. As the ASR output may be in lowercase and without digits and punctuation except apostrophes, we normalize the reference text by mapping numbers to spoken forms and removing punctuation before computing BLEU using SACRE-BLEU. To evaluate the naturalness of the speech output, we collect mean opinion scores (MOS) from human listening tests. We randomly sample 200 utterances for each system, and each sample is rated by 5 raters on a scale of 1 (the worst) to 5 (the best).

In particular embodiments, the textless speech-to-speech translation (S2ST) model may be based on speech normalization, S2UT, and unit-based vocoder. For speech normalization, we finetune the mHuBERT model for English, Spanish and French, respectively, resulting in three language-dependent speech normalizers. We perform CTC finetuning for 25k updates with the transformer parameters fixed for the first 10k steps. We use Adam with β₁=0.9, β₂=0.98, ∈=10⁻⁸, and 8k warm-up steps and then exponentially decay the learning rate. We tune the learning rate and masking probabilities on the dev sets based on unit error rate (UER) between the model prediction and the reference target units.

For S2UT, we use a conventional model architecture and training procedure but incorporate a larger speech encoder and unit decoder with embedding size 512 and 8 attention heads. We train the models for 600k steps for the second experimental multilingual S2ST data, and 800k steps for the combination of the second experimental multilingual dataset and mined data. The model with the best BLEU on the dev set is used for evaluation. All S2UT systems including the baselines are trained with an auxiliary task weight of 8.0.

For unit-based vocoder, we train one vocoder for each language, respectively. All vocoders are trained with orig-unit sequences as input, since they contain the duration information of natural speech for each unit. We use a conventional training procedure and train for 500k updates with the weight on the MSE loss set to 1.0. The vocoder is used for generating speech from either orig-unit or norm-unit, as they originate from the same K-means clustering process.

TABLE 4
BLEU and MOS (reported with 95% confidence interval) from systems trained in a single run with the
second experimental multilingual S2ST data and evaluated on the experimental European multilingual test sets.
The best results from S2UT with norm-unit are highlighted in bold,
(tgt spkemb: target speaker embedding, SN: speech normalization, gt: ground truth, tf: transformer).

| | | tgt | tgt | tgt | BLEU (↑) | | | | MOS (↑) | | | |
|---|---|---|---|---|---|---|---|---|---|---|---|---|
| ID | | spkemb | SN | text | Es-En | Fr-En | En-Es | En-Fr | Es-En | Fr-En | En-Es | En-Fr |
| 1 | S2UT w/ | x | x | x | 13.1 | 15.4 | 16.4 | 15.8 | 2.32 ± 0.10 | 2.43 ± 0.11 | 2.97 ± 0.14 | 2.41 ± 0.08 |
| | orig-unit | | | | | | | | | | | |
| 2 | S2UT w/ | ✓ | x | x | 16.1 | 16.6 | 19.3 | 15.6 | 2.29 ± 0.11 | 2.25 ± 0.10 | 3.48 ± 0.01 | 2.25 ± 0.06 |
| | orig-unit | | | | | | | | | | | |
| 3 | S2UT w/ | x | 10-min | x | 17.8 | 18.5 | 20.4 | 16.8 | 2.99 ± 0.07 | 3.16 ± 0.07 | 3.92 ± 0.11 | 2.65 ± 0.08 |
| | norm-unit | | | | | | | | | | | |
| 4 | S2UT w/ | x | 1-hr | x | 18.8 | 20.3 | 21.8 | 18.7 | 3.20 ± 0.09 | 3.26 ± 0.08 | 4.09 ± 0.11 | 2.92 ± 0.09 |
| | norm-unit | | | | | | | | | | | |
| 5 | S2UT w/ | x | 10-hr | x | 18.9 | 19.9 | 22.7 | 18.7 | 3.26 ± 0.08 | 3.27 ± 0.08 | 4.17 ± 0.10 | 2.84 ± 0.08 |
| | norm-unit | | | | | | | | | | | |
| 6 | S2T + tf | x | x | ASR | 19.2 | 19.8 | 21.7 | 18.5 | 3.23 ± 0.13 | 3.22 ± 0.11 | 4.12 ± 0.11 | 2.44 ± 0.08 |
| | TTS | | | | | | | | | | | |
| 7 | S2T + T2U | x | x | ASR | 19.4 | 19.7 | 21.8 | 18.9 | 3.16 ± 0.08 | 3.21 ± 0.07 | 4.11 ± 0.11 | 2.87 ± 0.09 |
| 8 | gt + tf | x | x | x | 88.0 | 87.2 | 82.0 | 69.2 | | | | |
| | TTS | | | | | | | | | | | |
| 9 | gt + T2U | x | x | x | 87.9 | 87.1 | 84.6 | 73.8 | | | | |

Table 4 summarizes the results from systems trained with the second experimental multilingual S2ST data. We also list the results from applying TTS on the ground truth reference text (8, 9) to demonstrate the impact from ASR errors and potentially low-quality speech on the BLEU score.

First, compared with the basic setup, the baseline with target speaker embedding can give a 1.23 BLEU improvement on three language pairs (1 versus 2), implying that there may exist variations in orig-unit sequences which are hard to model without extra information from the target speech signals. However, with only 10 minutes of paired multiple-to-single speaker speech data, we obtain norm-unit that improves S2UT model performance by 1.5 BLEU on average (2 versus 3). The translation quality improves as we increase the amount of parallel data for training the speech normalizer. In the end, with 10 hours of finetuning data, we obtain an average 4.9 BLEU gain from the four language pairs compared to the basic setup (1 versus 5).

On the other hand, compared with S2T+TTS systems that uses extra ASR models for converting speech to text for training the translation model (6, 7), our best textless S2ST systems (5) can perform similarly to text-based systems without the need of human annotations for building the ASR models.

We see that the MOS of S2UT systems trained with orig-unit is on average 0.85 lower than that of systems trained with norm-unit (1 versus 5). We notice that the former often produces stuttering in the output speech, a potential cause to lower MOS. While worse audio quality may affect ASR-based evaluation and lead to lower BLEU, we verify that this may be not the case as the ASR models may still capture the content. We also see that the proposed textless S2ST system can produce audios with similar naturalness as transformer TTS models (5 versus 6).

Next, we add the mined S2ST data for model training, and the results are summarized in Table 5. We apply the speech normalizer trained with 1-hr data, as it may provide similar translation performance as a speech normalizer trained with 10-hr data in the second experimental multilingual dataset only experiments (4 versus 5 in Table 4).

On the experimental European multilingual test set, we see consistent trend across the S2UT models trained with norm-unit and the two baselines with orig-unit, where the proposed approach gives on average 3.9 BLEU improvement compared to the basic setup (10 versus 12), indicating that the speech normalizer trained on the second experimental multilingual dataset and the experimental voice audio dataset may also be applied to audios from different domains, e.g. the experimental read audiobooks dataset, where the mined data is collected. The addition of mined data with the proposed speech normalization technique achieves an average of 2.0 BLEU gain over four language directions (4 versus 12).

We also examine model performance on the expanded voice audio test set and see even larger improvements brought by mined data (10, 11, 12 versus 4). One possible reason for this may be that the experimental read audiobooks dataset is more similar to the domain of the expanded voice audio dataset than that of the experimental European multilingual dataset. With target speaker embedding, mined data improves S2ST by 7.1 BLEU on average (4 versus 11). S2UT with norm-unit does not perform as well, and one explanation may be that we select the best model based on the experimental European multilingual dev set during model training.

Compared with S2T+TTS systems trained with text obtained from ASR, there is an average of 0.6 BLEU gap from our proposed system on the experimental European multilingual test sets (12 versus 14). As the English ASR model was trained on the first experimental multilingual S2ST dataset, it may decode high-quality text output for the mined data. We also list results from the S2T systems (15, 16), which shows the impact of having oracle text and in-domain training data and serves as an upper bound for the textless S2ST system performance.

We analyze norm-unit to understand how the speech normalization process helps improve S2UT performance. First, to verify that the process preserves the lexical content, we perform a speech resynthesis study. We use the second experimental multilingual ASR test sets, run the unit-based vocoder with different versions of discrete units extracted from the audio as input, and compute word error rate (WER) of the audio output. In addition to comparing between norm-unit and reduced orig-unit, we list the WER from the original audio to demonstrate the quality of the ASR models and the gap caused by the unit-based vocoder.

TABLE 5
BLEU scores (↑) from systems trained in a single run with the combination of the second experimental
multilingual data (VP) and mined S2ST data and evaluated on the experimental European multilingual
dataset (EP) and the expanded voice audio (CVST) test sets. The S2T (conventional) model is trained
on more than 500 hours of S2T data. The best results from S2UT with VP + mined data are highlighted in
bold, (tgt spkemb: target speaker embedding, SN: speech normalization, gt: ground truth, tf: transformer)

| | | | tgt | tgt | tgt | Es-En | | Fr-En | | En-Es | En-Fr |
|---|---|---|---|---|---|---|---|---|---|---|---|
| ID | | data | spkemb | SN | text | EP | CVST | EP | CVST | EP | EP |
| 4 | S2UT w/ | VP | x | 1-hr | x | 18.8 | 9.2 | 2.03 | 9.6 | 21.8 | 18.7 |
| | norm-unit | | | | | | | | | | |
| 10 | S2UT w/ | VP + mined | x | x | x | 16.7 | 12.0 | 17.2 | 16.7 | 19.9 | 18.2 |
| | orig-unit | | | | | | | | | | |
| 11 | S2UT w/ | VP + mined | ✓ | x | x | 18.2 | 16.3 | 19.1 | 16.6 | 21.6 | 18.6 |
| | orig-unit | | | | | | | | | | |
| 12 | S2UT w/ | VP + mined | x | 1-hr | x | 21.2 | 15.1 | 22.1 | 15.9 | 24.1 | 20.3 |
| | norm-unit | | | | | | | | | | |
| 13 | S2T + tf TTS | VP + mined | x | x | ASR | 21.4 | 14.8 | 22.4 | 16.7 | 24.3 | 20.9 |
| 14 | S2T + T2U | VP + mined | x | x | ASR | 21.3 | 14.9 | 22.3 | 16.7 | 24.8 | 21.6 |
| 15 | S2T | VP + EP + CVST | x | x | Oracle | 26.0 | 27.3 | 28.1 | 27.7 | — | — |
| | (conventinal) + | | | | | | | | | | |
| | tfTTS | | | | | | | | | | |
| 16 | S2T | VP + EP + CVST | x | x | Oracle | 26.0 | 26.9 | 28.1 | 27.3 | — | — |
| | (conventional) + | | | | | | | | | | |
| | tf T2U | | | | | | | | | | |
| 8 | gt + tf TTS | x | x | x | x | 88.0 | 80.7 | 87.2 | 77.3 | 82.0 | 68.6 |
| 9 | gt + T2U | x | x | x | x | 87.9 | 78.8 | 87.1 | 75.9 | 84.6 | 73.8 |

TABLE 6
Speech resynthesis results on the second experimental
multilingual S2ST ASR test set.

| UER (↓) | English | Spanish | French |
|---|---|---|---|
| original audio | 14.2 | 15.5 | 18.5 |
| reduced orig-unit | 22.4 | 22.7 | 24.1 |
| norm-unit (10 min) | 23.5 | 25.3 | 31.7 |
| norm-unit (1-hr) | 21.2 | 20.5 | 24.6 |
| norm-unit (10-hr) | 22.0 | 25.3 | 24.2 |

TABLE 7
Unit error rate (UER) between units extracted from 400 pairs
of audios from the experimental voice audio dataset.

| UER (↓) | English | Spanish | French |
|---|---|---|---|
| reduced orig-unit | 74.4 | 70.6 | 73.5 |
| norm-unit (1-hr) | 48.2 | 31.6 | 46.4 |

We see from Table 6 that norm-unit from a speech normalizer finetuned on 1-hr data achieves similar WER as orig-unit, indicating that the normalization process may not change the content of the speech. In addition, we observe that norm-unit sequences are on average 15% shorter than reduced orig-unit sequences. We find that this may be mainly due to the fact that the speech normalizer does not output units for the long silence in the audio, while reduced orig-unit encodes non-speech segments such as silence and background noises. Therefore, norm-unit is a shorter and cleaner target for training S2UT models.

Next, to examine that the speech normalizer reduces variations in speech across speakers, we sample 400 pairs of audios from the experimental voice audio dataset for English, Spanish and French, respectively. Each pair contains two speakers reading the same text prompt. Table 7 shows the unit error rate (UER) between the unit sequences extracted from the paired audios. We see that norm-unit has UER that is on average 58% of the UER of reduced orig-unit, showing that norm-unit may have less variations across speakers.

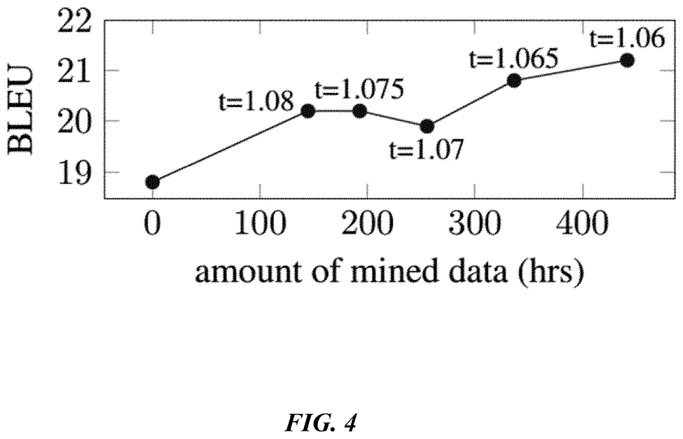

Each pair of aligned speech in the mined data has an associated semantic similarity score. In experiments above, we set the score threshold as 1.06, and use all mined data with scores above it. Given the trade-off between the quality and quantity of mined data, we analyze how the speech-to-speech translation (S2ST) performance changes with the threshold set in mined data selection. FIG. 4 illustrates example BLEU scores on the experimental European multilingual Es-En test set from S2UT systems trained with 1-hr norm-unit. The mined data may be useful at different thresholds given its gains over the model trained without mined data. As we increase the threshold from 1.06 to 1.07, the performance drops due to less training data.

Table 8 lists the details for the three iterations of mHuBERT training.

TABLE 8
Setup for the target labels used in mHuBERT training.

| iteration | target features | K-means |
|---|---|---|
| 1 | MFCC | 100 |
| 2 | 6-th layer from the first iteration | 500 |
| 3 | 9-th layer from the second iteration | 500 |

Table 9 shows the resynthesis performance of the unit-based vocoder of each language. The WER on the original audio indicates the quality of the open-sourced ASR model we use for evaluation. The WER difference between original audio and orig-unit shows the quality of the vocoder, and the difference between orig-unit and reduced orig-unit shows the further impact brought by the duration prediction module.

TABLE 9
WER on the TTS dev sets (the first experimental multilingual S2ST
dataset for English, and the 10-language speech dataset for Spanish
and French) of the audios resynthesized from units.

| WER (↓) | English | Spanish | French |
|---|---|---|---|
| original audio | 2.0 | 8.4 | 24.0 |
| orig-unit | 2.8 | 12.0 | 29.3 |
| reduced orig-unit | 3.4 | 11.9 | 31.3 |

Table 10 lists the WER of the audios generated by the T2U model, which is used in generating the reference target units for speech normalizer training. As the T2U model is trained with reduced unit sequences as the target, during synthesis, we apply the unit-based vocoder with duration prediction. We may see that T2U with a unit-based vocoder may produce high-quality audio and serve as another option of TTS.

TABLE 10
WER on the TTS dev sets (the first experimental multilingual
S2ST dataset for English, and the 10-language speech
dataset for Spanish and French).

| WER (↓) | English | Spanish | French |
|---|---|---|---|
| original audio | 2.0 | 8.4 | 24.0 |
| T2U | 4.2 | 9.1 | 24.4 |

Table 11 lists the best hyper-parameters for training the speech normalizers for the three languages and three data setups, respectively. All models are trained on 8 GPUs with a batch size of 100-second (maximum total input audio length).

TABLE 11
Hyper-parameters for training the speech normalizers.

| language | duration | learning rate | mask prob | mask channel prob |
|---|---|---|---|---|
| English | 10-min | 0.00003 | 0.75 | 0.75 |
| English | 1-hr | 0.0005 | 0.5 | 0.5 |
| English | 10-hr | 0.0001 | 0.5 | 0.75 |
| Spanish | 10-min | 0.00003 | 0.5 | 0.75 |
| Spanish | 1-hr | 0.00003 | 0.5 | 0.25 |
| Spanish | 10-hr | 0.00005 | 0.5 | 0.5 |
| French | 10-min | 0.00003 | 0.5 | 0.5 |
| French | 1-hr | 0.00005 | 0.5 | 0.25 |
| French | 10-hr | 0.00005 | 0.5 | 0.25 |

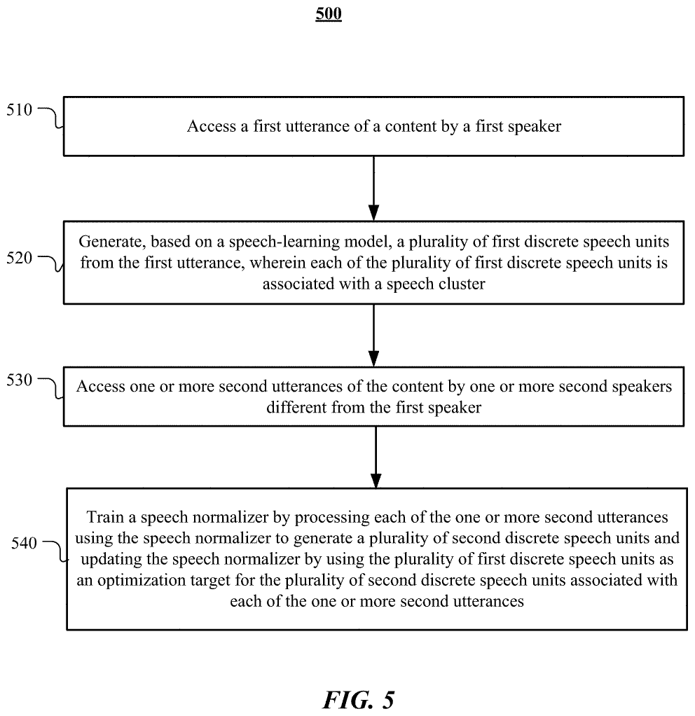

FIG. 5 illustrates an example method 500 for training a speech normalizer. The method may begin at step 510, where the computing system may access a first utterance of a content by a first speaker. At step 520, the computing system may generate, based on a speech-learning model, a plurality of first discrete speech units from the first utterance, wherein each of the plurality of first discrete speech units is associated with a speech cluster. At step 530, the computing system may access one or more second utterances of the content by one or more second speakers different from the first speaker. At step 540, the computing system may train a speech normalizer by processing each of the one or more second utterances using the speech normalizer to generate a plurality of second discrete speech units and updating the speech normalizer by using the plurality of first discrete speech units as an optimization target for the plurality of second discrete speech units associated with each of the one or more second utterances. Although this disclosure describes accessing a single utterance, this disclosure contemplates accessing any suitable number of utterances, e.g., a batch of utterances, in any suitable manner. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for training a speech normalizer including the particular steps of the method of FIG. 5, this disclosure contemplates any suitable method for training a speech normalizer including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

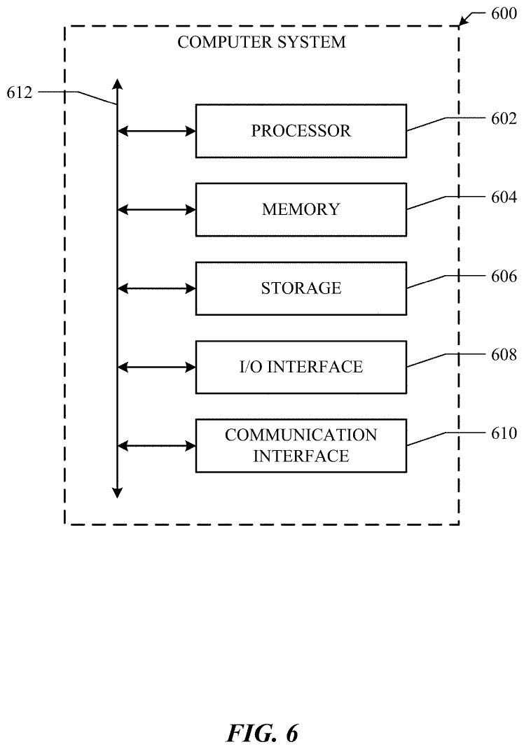

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing systems:
accessing a first utterance of a content by a first speaker;
generating, based on a speech-learning model, a plurality of first discrete speech units from the first utterance, wherein each of the plurality of first discrete speech units is associated with a speech cluster;
accessing one or more second utterances of the content by one or more second speakers different from the first speaker; and
training a speech normalizer by:
processing each of the one or more second utterances using the speech normalizer to generate a plurality of second discrete speech units; and
updating the speech normalizer by using the plurality of first discrete speech units as an optimization target for the plurality of second discrete speech units associated with each of the one or more second utterances.

2. The method of claim 1, wherein generating the plurality of first discrete speech units comprises:
generating a plurality of intermediate representations by processing the first utterance with the speech-learning model; and
applying one or more clustering algorithms to the plurality of intermediate representations.

3. The method of claim 1, further comprising:
reducing one or more repeating first content units from the plurality of first content units.

4. The method of claim 1, wherein the trained speech normalizer comprises one or more of a finetuned speech-learning model or a decoder.

5. The method of claim 1, further comprising:
accessing a third utterance by a third speaker; and
processing the third utterance using the trained speech normalizer to generate a plurality of normalized speech units.

6. The method of claim 5, further comprising:
anonymizing the third speaker based on removing one or more normalized speech units associated with speech characteristics specific to the third speaker from the plurality of normalized speech units.

7. The method of claim 5, further comprising:
denoising the third utterance based on removing one or more normalized speech units corresponding to background noises from the plurality of normalized speech units.

8. The method of claim 5, further comprising:
removing one or more normalized speech units corresponding to silence longer than a threshold time from the plurality of normalized speech units.

9. The method of claim 1, further comprising:
processing a plurality of first training data associated with a target language by the trained speech normalizer to generate a plurality of normalized target speech units; and
training a textless speech-to-speech translation model based on the plurality of normalized target speech units and a plurality of second training data associated with a source language.

10. One or more computer-readable non-transitory storage media embodying software that is operable when executed to:
access a first utterance of a content by a first speaker;
generate, based on a speech-learning model, a plurality of first discrete speech units from the first utterance, wherein each of the plurality of first discrete speech units is associated with a speech cluster;
access one or more second utterances of the content by one or more second speakers different from the first speaker; and
train a speech normalizer by:
processing each of the one or more second utterances using the speech normalizer to generate a plurality of second discrete speech units; and
updating the speech normalizer by using the plurality of first discrete speech units as an optimization target for the plurality of second discrete speech units associated with each of the one or more second utterances.

11. The media of claim 10, wherein generating the plurality of first discrete speech units comprises:
generating a plurality of intermediate representations by processing the first utterance with the speech-learning model; and
applying one or more clustering algorithms to the plurality of intermediate representations.

12. The media of claim 10, wherein the software is further operable when executed to:
reduce one or more repeating first content units from the plurality of first content units.

13. The media of claim 10, wherein the trained speech normalizer comprises one or more of a finetuned speech-learning model or a decoder.

14. The media of claim 10, wherein the software is further operable when executed to:
access a third utterance by a third speaker; and
process the third utterance using the trained speech normalizer to generate a plurality of normalized speech units.

15. The media of claim 14, wherein the software is further operable when executed to:
anonymize the third speaker based on removing one or more normalized speech units associated with speech characteristics specific to the third speaker from the plurality of normalized speech units.

16. The media of claim 15, wherein the software is further operable when executed to:
denoise the third utterance based on removing one or more normalized speech units corresponding to background noises from the plurality of normalized speech units.

17. The media of claim 15, wherein the software is further operable when executed to:
remove one or more normalized speech units corresponding to silence longer than a threshold time from the plurality of normalized speech units.

18. The media of claim 10, wherein the software is further operable when executed to:
process a plurality of first training data associated with a target language by the trained speech normalizer to generate a plurality of normalized target speech units; and
train a textless speech-to-speech translation model based on the plurality of normalized target speech units and a plurality of second training data associated with a source language.

19. A system comprising: one or more processors; and a non-transitory memory coupled to the processors comprising instructions executable by the processors, the processors operable when executing the instructions to:
access a first utterance of a content by a first speaker;
generate, based on a speech-learning model, a plurality of first discrete speech units from the first utterance, wherein each of the plurality of first discrete speech units is associated with a speech cluster;
access one or more second utterances of the content by one or more second speakers different from the first speaker; and
train a speech normalizer by:
processing each of the one or more second utterances using the speech normalizer to generate a plurality of second discrete speech units; and
updating the speech normalizer by using the plurality of first discrete speech units as an optimization target for the plurality of second discrete speech units associated with each of the one or more second utterances.

20. The system of claim 19, wherein the processors are further operable when executing the instructions to:
process a plurality of first training data associated with a target language by the trained speech normalizer to generate a plurality of normalized target speech units; and
train a textless speech-to-speech translation model based on the plurality of normalized target speech units and a plurality of second training data associated with a source language.
